(19) United States
(12) Patent Application Publication
(10) Pub. No.: US 2026/0066342 A1
(43) Pub. Date: Mar. 5, 2026

(54) SOLID ELECTROLYTE POWDER COATED WITH Li-Al-O COMPOUND, SINTERED BODY COMPRISING THE SAME, AND METHOD FOR MANUFACTURING THE SAME

(71) Applicant: KOREA RESEARCH INSTITUTE OF STANDARDS AND SCIENCE, Daejeon (KR)

(72) Inventors: Seung-wook Baek, Daejeon (KR); Hwa-jung Kim, Daejeon (KR); Hyeokjun Park, Seoul (KR); Hosun Shin, Daejeon (KR); Minseo Choi, Daejeon (KR)

(21) Appl. No.: 19/308,080

(22) Filed: Aug. 22, 2025

(30) Foreign Application Priority Data
Aug. 30, 2024 (KR) 10-2024-0117552
Jul. 14, 2025 (KR) 10-2025-0094259

(51) Int. Cl. H01M 10/0562

(52) U.S. Cl. CPC H01M 10/0562; H01M 2300/0077; H01M 2300/0094

(57) ABSTRACT

Provided is an oxide-based solid electrolyte powder including a base powder, and a coating layer on a surface of the base powder, wherein the coating layer including a Li—Al—O compound, and a method for manufacturing an oxide-based solid electrolyte sintered body including coating a base powder with a material comprising a Li—Al—O compound to form a coated powder, and sintering the coated powder, wherein the sintering is performed without a mother powder.

### CROSS-REFERENCE TO RELATED APPLICATION

This application claims priority of Korean Patent Application No. 10-2024-0117552, filed on Aug. 30, 2024, and priority of Korean Patent Application No. 10-2025-0094259, filed on Jul. 14, 2025, in the KIPO (Korean Intellectual Property Office), the disclosure of which is incorporated herein entirely by reference.

### BACKGROUND OF THE INVENTION

### Field of the Invention

The present invention relates to a powder for a high-stability oxide-based solid electrolyte, a high-stability oxide-based solid electrolyte including the same, and a method for manufacturing the same.

### Description of the Related Art

In the conventional fabrication of oxide-based solid electrolyte membranes for secondary batteries, long-duration high-temperature heat treatments (e.g., ˜1250° C. for 12 hours) have been employed. However, such processes lead to lithium volatilization within the oxide solid electrolyte, thereby compromising the structural stability of the material. In addition, reactions with atmospheric components such as carbon dioxide can alter the surface composition of the electrolyte, causing phase transitions or reduced sinterability, which in turn result in lower ionic conductivity.

Furthermore, when fabricating solid electrolyte membranes via general pressureless sintering methods, it is necessary to place the pellets within a large amount of mother powder (also known as bed powder or covering powder)—typically five times the volume of the intended sintered body—to prevent structural collapse due to lithium loss and to avoid pellet warping or cracking caused by uneven heat transfer. However, this approach significantly increases material consumption and raises production costs.

In response, various techniques have been attempted, such as hot pressing (HP), spark plasma sintering (SPS), and ultrafast high-temperature sintering (UHS), which apply external pressure or achieve rapid sintering. While these methods offer certain advantages, they suffer from drawbacks including high equipment costs, difficulties in mass production and scale-up, and incompatibility with tape casting processes.

### SUMMARY OF THE INVENTION

Accordingly, the present invention aims to overcome the aforementioned problems of the prior art by providing an oxide-based solid electrolyte powder that exhibits high sinterability, excellent structural stability, and high density without the use of mother powder. The invention further provides a highly stable oxide-based solid electrolyte comprising the powder, a sintered body formed therefrom, and a method for manufacturing the same.

The present invention provides an oxide-based solid electrolyte powder comprising a base powder and a coating layer formed on the surface of the powder, the coating layer containing a Li—Al—O compound.

In one embodiment of the present invention, the base powder may be an oxide-based solid electrolyte powder that does not contain any Li—Al—O compound.

In another embodiment, the powder may be selected from garnet-type Li₇La₃Zr₂O₁₂ (LLZ) or Ta-doped Li_{6.4}La₃Zr_{1.4}Ta_{0.6}O₁₂ (LLZT).

In still another embodiment, the coating layer may be formed by a sol-gel method, in an amount of 0.5 to 5.0 wt % relative to the powder.

The present invention also provides a method for producing an oxide-based solid electrolyte sintered body, the method comprising the steps of coating a powder with a material containing a Li—Al—O compound, and sintering the coated powder without using any mother powder.

In one embodiment, the coating step may be performed using a sol-gel solution comprising a lithium precursor and an aluminum precursor.

In another embodiment, the sintering may be carried out immediately after the coating step without a separate crystallization process.

In another embodiment, the sintering may be performed at a temperature of 1000° C. to 1100° C. under an oxygen atmosphere.

In a further embodiment, the sintered body may exhibit a shrinkage rate increase of at least 15% and a relative density of 95% or more, compared to a sintered body produced without coating or mother powder.

In another embodiment, the sintered body may retain a cubic phase structure without collapse and may be free of secondary phases.

The present invention also provides an oxide-based solid electrolyte sintered body comprising a core of Ta-doped Li₇La₃Zr₂O₁₂ (LLZT) and a Li—Al—O compound distributed at the grain boundaries of the core, wherein the sintered body has a relative density of 95% or more and a cubic phase.

In one embodiment, the oxide-based solid electrolyte sintered body may be included in an all-solid-state secondary battery.

According to the present invention, by using a powder in which the surface of the solid electrolyte powder is coated with a Li—Al—O compound (LiAlO₂) via a sol-gel method, it is possible to fabricate a high-density solid electrolyte membrane without the use of mother powder. Unlike the simple addition of LiAlO₂ or Al₂O₃ powders-which results in degraded density, crystallinity, and even disintegration of the sintered body—the application of a Li—Al—O compound as a sol-gel-derived coating layer achieves excellent properties, including a high shrinkage ratio of 21% and a relative density of 96.1%.

Furthermore, the Li—Al—O coating enhances the structural stability of the sintered body, as confirmed by XRD analysis, which shows the retention of a stable cubic phase without structural collapse or formation of secondary phases.

In terms of electrochemical properties, the sintered body exhibits low electronic conductivity (7.59×10⁻¹⁰ S/cm) and high ionic conductivity (1.01×10⁻³ S/cm) at room temperature.

With respect to lithium stability, the material demonstrates excellent cycling stability (3,500 hours at 0.2 mA/cm²) and a high critical current density of 2.5 mA/cm².

Therefore, the present invention enables direct sintering after the coating step without requiring a separate crystallization process, reducing processing costs. It also allows for large-scale and large-area sintered body production, thereby contributing to the fabrication of high-energy-density, large-format oxide-based solid-state batteries.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 is a process flow diagram illustrating the steps for fabricating a solid electrolyte according to the embodiments and comparative examples of the present invention.

FIGS. 2 and 3 are images of solid electrolyte pellets prepared in the embodiments and comparative examples.

FIGS. 4 and 5 show images before and after sintering of solid electrolytes. FIG. 4 shows the pre-sintered image of LLZT powder coated with a Li—Al—O compound via sol-gel method without using mother powder, and FIG. 5 shows the sintered body (LAO@LLZT) after the sintering process.

FIG. 6 is an image of a large-area solid electrolyte sintered body fabricated via large-area sintering.

FIGS. 7 and 8 are comparative graphs showing the shrinkage and relative density of the fabricated solid electrolyte sintered body compared with those of the comparative examples.

FIG. 9 is the XRD analysis result confirming the stable cubic phase of the fabricated solid electrolyte sintered body.

FIG. 10 is an SEM image showing the fracture surface of the fabricated solid electrolyte sintered body.

FIG. 11 shows the ICP measurement results of the fabricated solid electrolyte sintered body for component analysis.

FIG. 12 presents XPS surface analysis results of the fabricated solid electrolyte sintered body.

FIGS. 13 and 14 show the electrical conductivity of the fabricated solid electrolyte sintered body and comparative graphs with sintered bodies made using mother powder.

FIGS. 15 and 16 illustrate the ionic conductivity measurements and corresponding comparison graphs.

FIG. 17 shows the interfacial resistance measurement results between the fabricated solid electrolyte sintered body and lithium.

FIG. 18 presents the long-term stability results at the lithium interface and critical current density of the fabricated solid electrolyte sintered body.

FIG. 19 includes an image, shrinkage and relative density data, and XRD analysis results of a solid electrolyte sintered body prepared by adding LiAlO₂ powder (comparative example).

FIG. 20 includes an image, shrinkage and relative density data, and XRD analysis results of a solid electrolyte sintered body prepared by adding Al₂O₃ powder (comparative example).

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “module”, a “block” or like, when used in the specification, represents a unit that processes at least one function or operation, and the unit or the like may be implemented by hardware or software or a combination of hardware and software.

Reference herein to a layer formed “on” a substrate or other layer refers to a layer formed directly on top of the substrate or other layer or to an intermediate layer or intermediate layers formed on the substrate or other layer. It will also be understood by those skilled in the art that structures or shapes that are “adjacent” to other structures or shapes may have portions that overlap or are disposed below the adjacent features.

In this specification, the relative terms, such as “below”, “above”, “upper”, “lower”, “horizontal”, and “vertical”, may be used to describe the relationship of one component, layer, or region to another component, layer, or region, as shown in the accompanying drawings. It is to be understood that these terms are intended to encompass not only the directions indicated in the figures, but also the other directions of the elements.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Now, turning to the invention, the present invention relates to a novel oxide-based solid electrolyte powder, where the surface of the powder is directly coated with a Li—Al—O compound using a sol-gel method. This allows for high-density solid electrolyte sintering without the need for mother powder, which typically increases cost and complexity.

The term “Li—Al—O compound” refers to any compound comprising lithium (Li), aluminum (Al), and oxygen (O). The coating layer is formed on the surface of the powder to suppress lithium volatilization during sintering and to enhance the bonding between particles, thereby improving sinterability. According to the embodiments of the present invention, the Li—Al—O compound may include, but is not limited to, LiAlO₂ or Li₅AlO₄.

A key feature of the invention is that the Li—Al—O compound is not simply mixed in powder form but rather applied as a coating layer on the surface of the solid electrolyte particles. In comparative examples where LiAlO₂ or Al₂O₃ was added as powder, sintered bodies were poorly formed without the use of mother powder, leading to disintegration and degraded crystallinity. In contrast, when a sol-gel-derived coating was applied according to the invention, structurally stable and crack-free, high-density solid electrolyte membranes could be obtained without any mother powder.

Furthermore, the process enables the fabrication of large-area sintered bodies and pellet-size scaling through standard furnace sintering, making it suitable for mass production and commercialization of large-format, high-energy-density oxide-based solid-state batteries.

The invention will now be described in further detail through the following examples and experimental results. However, the scope of the invention is not limited thereto.

### Example

In one embodiment of the present invention, a solid electrolyte powder was prepared using a Ta-doped garnet-type cubic-phase solid electrolyte, specifically Li_{6.4}La₃Zr_{1.4}Ta_{0.6}O₁₂ (LLZT), as the base powder for the solid electrolyte.

In Example 1, the LLZT powder was coated via a sol-gel process and directly sintered at 1100° C. for 10 hours under an oxygen atmosphere, without a separate crystallization step. In Example 2, the LLZT powder underwent a sol-gel coating process followed by a crystallization step, and was then sintered under the same conditions as in Example 1.

For comparison, comparative Example 1 involved sintering the LLZT powder under the same conditions without any sol-gel coating. comparative Examples 2 and 3 were also prepared by adding 1.2 wt % of Al₂O₃(AO) and LiAlO₂ (LAO), respectively, to the powder. Each was sintered under the same conditions, both with (MP: with mother powder) and without (bare: no mother powder) the use of mother powder.

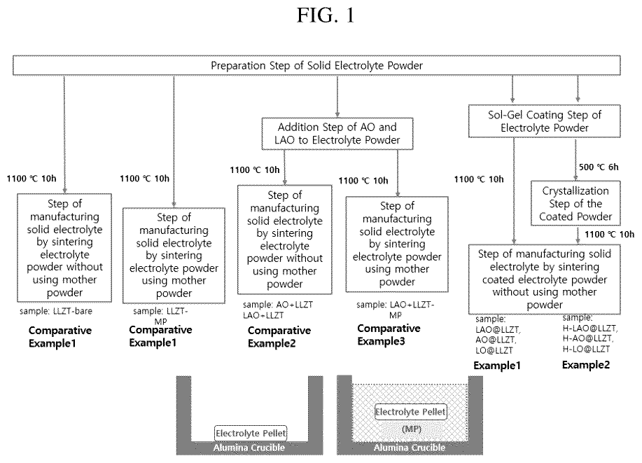

The detailed processing conditions for each case are illustrated in FIG. 1.

The naming convention for each sample used in these examples is as follows.

In the present embodiment, the naming convention for each sample is as follows.

Samples fabricated using the conventional solid electrolyte sintering method with the use of mother powder are labeled with the suffix “MP,” which stands for “mother powder.” For example, LLZT-MP refers to LLZT sintered using mother powder.

When a compound is added directly to the solid electrolyte powder, the symbol “+” is used in the name, followed by an abbreviation of the added compound. For instance, “LAO” represents a Li—Al—O compound, and “AO” indicates an Al—O compound.

When a compound is applied as a coating to the surface of the solid electrolyte powder, the symbol “@” is used. For example, LAO@LLZT refers to LLZT powder coated with a Li—Al—O compound, while AO@LLZT refers to LLZT coated with an Al—O compound.

If the coating process is followed by a heat treatment step, the prefix “H—” is added. Thus, H-LAO@LLZT indicates LLZT powder coated with a Li—Al—O compound and subsequently heat-treated.

### Sample Naming Rule

When a conventional sintering route employing mother powder is used, the suffix “MP” (mother powder) is appended—e.g., LLZT-MP. If a compound is added to the solid-electrolyte powder, a “+” sign is inserted, followed by the abbreviation of the additive: LAO for Li—Al—O compounds and AO for Al—O compounds.

If a compound is applied as a coating, the symbol “@” precedes the compound abbreviation-thus LAO@LLZT or AO@LLZT. When the sol-gel coating is followed by a heat-treatment step, the prefix “H—” is placed in front of the name, as in H-LAO@LLZT.

### Process Flow (Illustrated in FIG. 1)

Powder Preparation—A cubic-phase, Ta-doped garnet powder, Li_{6.4}La₃Zr_{1.4}Ta_{0.6}O₁₂ (LLZT), is synthesized and used as the solid-electrolyte starting powder.

Surface Coating—A sol-gel solution is prepared by dissolving selected precursors in isopropanol (IPA).

For the Li—Al—O coating, Li-ethoxide and Al-ethoxide are employed.

For the Li—O comparative sample, only Li-ethoxide is used; for the Al—O comparative sample, only Al-ethoxide is used. The solution is formulated so that, after processing, ˜2 wt % of LiAlO₂, Al₂O₃ or Li₂O will be present on the powder. The powder is dispersed in the solution and stirred magnetically on a hot plate at 120° C., 120 rpm for 6-12 h to evaporate IPA and form the coating. In Example 2, an additional crystallization step is carried out by heating the coated powder at 500° C. for 6 h.

Sintering of Solid Electrolyte—Approximately 1 g of the (coated or additive-containing) powder is uniaxially pressed at 3-4 tons to form green pellets. Pellet diameters from 10 mm to 65 mm are explored.

The pellets are placed in alumina, magnesia, or platinum crucibles and sintered at 1000-1100° C. for 10 h under flowing high-purity O₂ (99.995%, ≥300 cc min⁻¹). No mother powder Is used during this step.

Beyond pellet fabrication, the coated powders can also be tape-cast or otherwise deposited onto substrates and sintered to obtain sheet-type solid-electrolyte structures, including both thin and thick films.

### Experimental Example

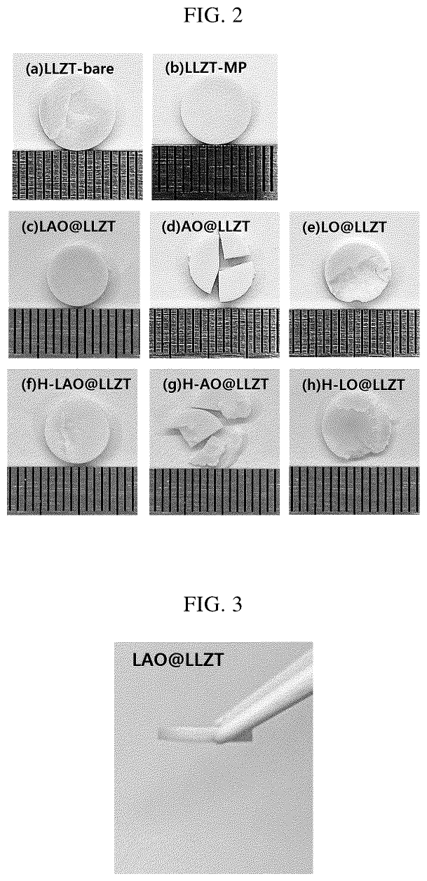

FIGS. 2 and 3 show images of solid electrolyte pellets fabricated according to the embodiments and comparative examples of the present invention.

As seen in FIG. 2(c), even without the use of mother powder, the LAO@LLZT sintered body exhibits a high shrinkage ratio of 21%. The side view in FIG. 3 confirms that the sintered body was fabricated without warping.

In contrast, in FIG. 2(a), LLZT-bare-sintered without mother powder-shows the formation of cracks and insufficient shrinkage. It also reveals a porous and non-dense structure after sintering.

Additionally, FIG. 2(b) (LLZT-MP), fabricated using the conventional sintering method with mother powder, displays a shrinkage ratio of 15%, indicating that the LAO@LLZT sintered body has superior sinterability.

Coated samples using Al—O and Li—O compounds-AO@LLZT (d) and LO@LLZT (e)—exhibited fracture and breakage of the sintered bodies.

Furthermore, even when using the same chemical components, sintered bodies subjected to crystallization heat treatment, such as in H—XO@LLZT (f-h), showed fracture and breakage, confirming inferior sinterability.

These results demonstrate that the use of a Li—Al—O coated solid electrolyte powder enables high sinterability without the use of mother powder. This not only reduces the cost associated with precursors and mother powders, but also lowers process costs by eliminating the need for additional crystallization heat treatment.

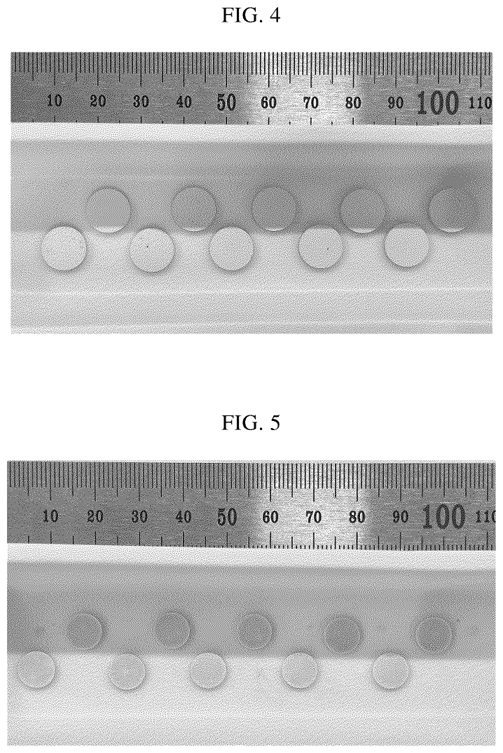

FIGS. 4 and 5 show images of the solid electrolyte before and after sintering.

FIG. 4 shows the LLZT powder coated with a Li—Al—O compound via sol-gel before sintering, and FIG. 5 shows the sintered LAO@LLZT after processing.

From these figures, it can be seen that the Li—Al—O coated LLZT powder achieves sufficient formability and uniform sintering without the use of mother powder.

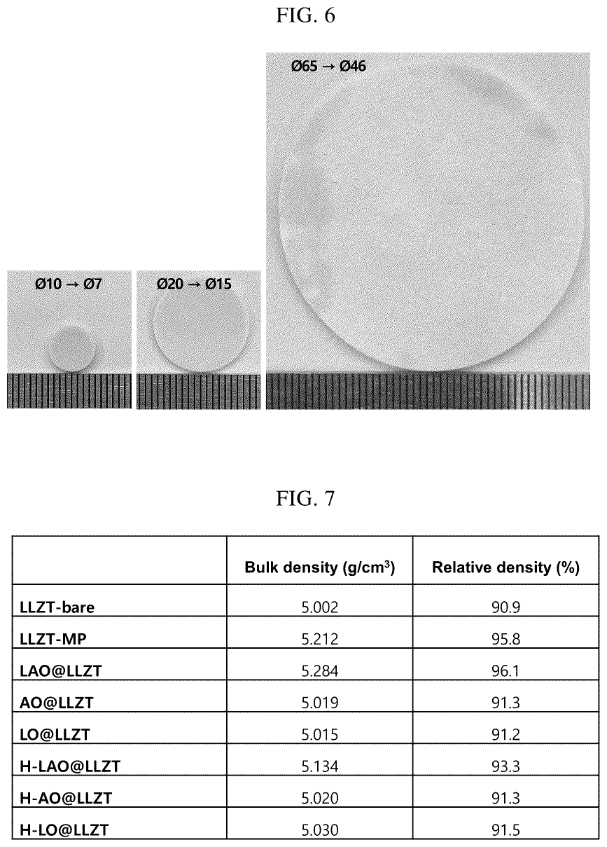

FIG. 6 shows an image of a large-area solid electrolyte sintered body fabricated via large-scale sintering.

The results indicate that using the Li—Al—O coated powder enables the production of large-area sintered bodies suitable for mass production.

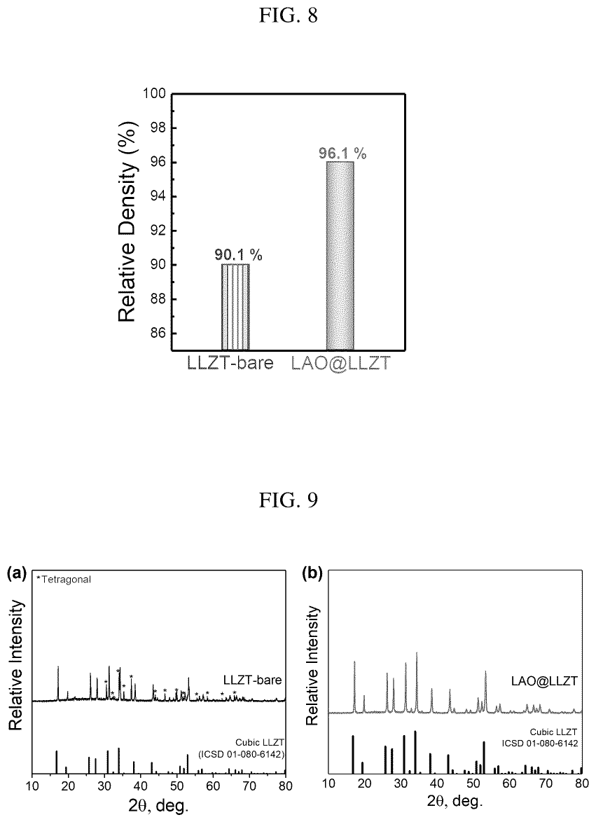

FIGS. 7 and 8 provide comparative graphs of the shrinkage and relative density of the fabricated sintered bodies.

As shown, the LAO@LLZT sintered body from Example 1 exhibited the highest density, even higher than that of LLZT-bare, proving that the Li—Al—O coated powder delivers both high sinterability and density.

FIG. 9 presents XRD analysis results verifying the phase stability of the sintered bodies.

According to the results, the LAO@LLZT sintered body maintained a stable cubic phase without structural collapse, whereas LLZT-bare showed structural instability and the emergence of a tetragonal phase. This confirms that Li—Al—O coating enhances structural stability during sintering.

FIG. 10 shows the fracture surface of the sintered body observed via SEM.

The LAO@LLZT sintered body displayed a dense structure with minimal porosity, while LLZT-bare showed a porous and loose microstructure. This further verifies the superior sinterability of the Li—Al—O coated powder.

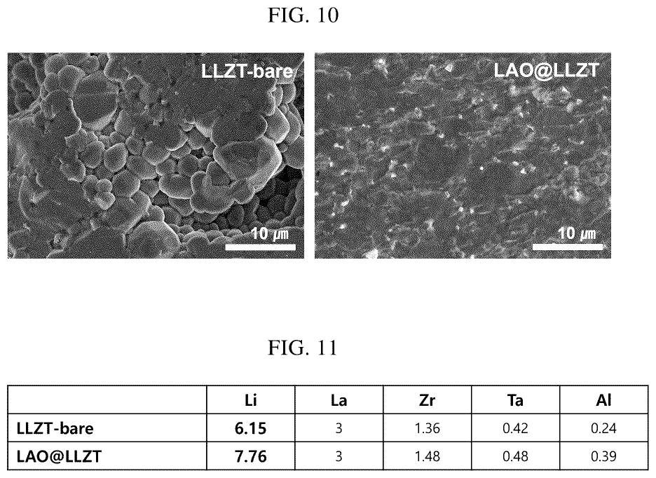

FIG. 11 provides the ICP measurement results of the fabricated sintered bodies.

The LAO@LLZT sintered body from Example 1 exhibited the highest lithium content, indicating minimal lithium volatilization at high temperatures. This supports the conclusion that Li—Al—O coating suppresses lithium loss and improves both sinterability and structural integrity.

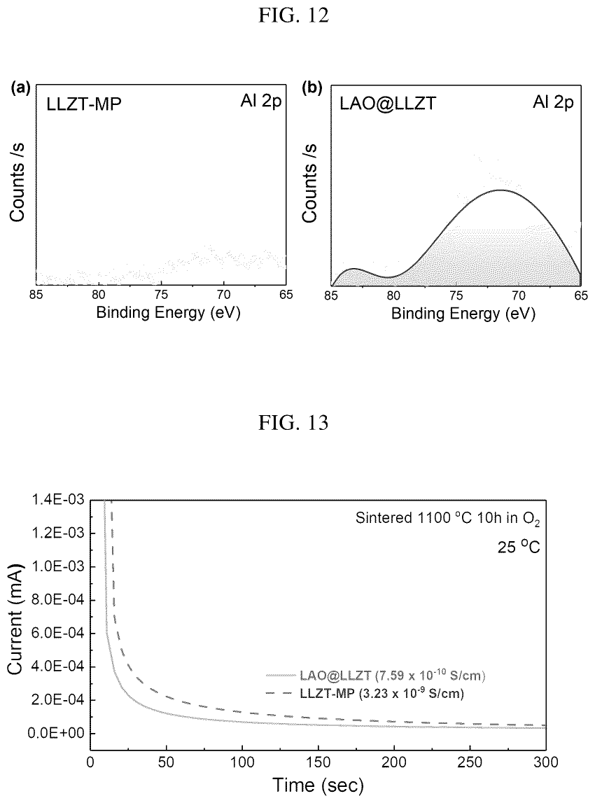

FIG. 12 shows the XPS surface analysis of the sintered bodies.

In LAO@LLZT (Example 1), aluminum was detected on the surface, while no aluminum was detected in LLZT-MP. This confirms that Li—Al—O coating contributes to high sinterability through surface and bulk distribution of aluminum.

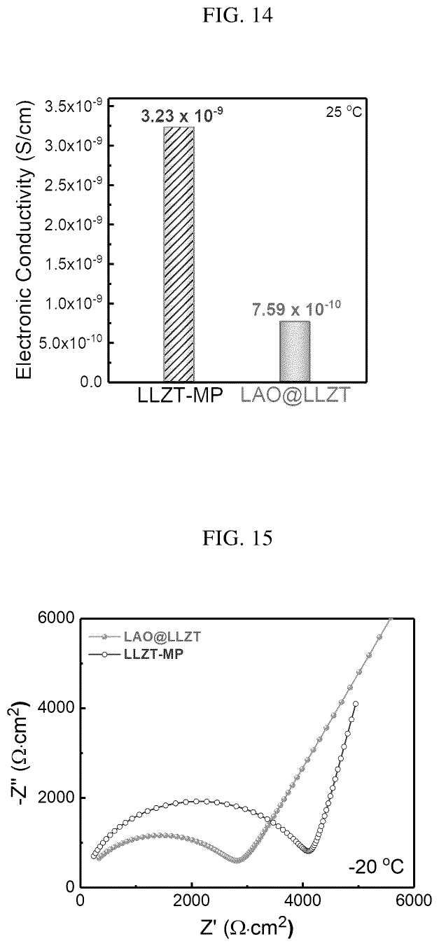

FIGS. 13 and 14 present the electrical conductivity results of the fabricated sintered bodies, including a comparison with the LLZT-MP sample.

Test samples were prepared by polishing both surfaces of the sintered pellets and depositing gold ion-blocking electrodes with high electronic conductivity. Conductivity was measured using the DC polarization technique, where a constant voltage is applied and the current is measured to calculate conductivity using Ohm's law.

As shown in FIGS. 13 and 14, the LAO@LLZT sintered body exhibited lower electronic conductivity than LLZT-MP. The quantitative results are summarized in Table 1.

TABLE 1

| Sample | Electronic Conductivity (S/cm) |
|---|---|
| LAO@LLZT | 7.59 × 10⁻¹⁰ |
| LLZT-MP | 3.23 × 10⁻⁹ |

FIGS. 15 and 16 show the ionic conductivity measurements of the fabricated sintered solid electrolytes and comparative graphs. The goal of both the electronic and ionic conductivity measurements is to evaluate the key characteristics of a solid electrolyte, which ideally exhibits high ionic conductivity and low electronic conductivity.

The test specimens were prepared by mirror-polishing both sides of the sintered body and depositing gold ion-blocking electrodes (Au) with high electronic conductivity.

Ionic conductivity was measured using impedance spectroscopy, where an AC voltage with an amplitude of 100 mV was applied over a frequency range from 500 Hz to 3 MHz. The bulk resistance of the electrolyte was determined from the real-axis intercept of the semicircular Nyquist plot, and ionic conductivity was calculated using the standard formula.

As shown in FIGS. 15 and 16, the sintered body fabricated using Li—Al—O coated powder exhibited higher ionic conductivity compared to LLZT-MP. At room temperature, it demonstrated a remarkably high ionic conductivity on the order of 10-3 S/cm, and even at lower temperatures, it maintained excellent ionic conductivity.

These results are summarized quantitatively in Table 2.

TABLE 2

| | Temperature-Dependent Ionic Conductivity (S/cm) | | |
|---|---|---|---|
| | 25° C. | 0° C. | −20° C. |
| LAO@LLZT | 1.01 × 10⁻³ | 1.22 × 10⁻⁴ | 4.00 × 10⁻⁵ |
| LLZT-MP | 3.79 × 10⁻⁴ | 9.16 × 10⁻⁵ | 2.08 × 10⁻⁵ |

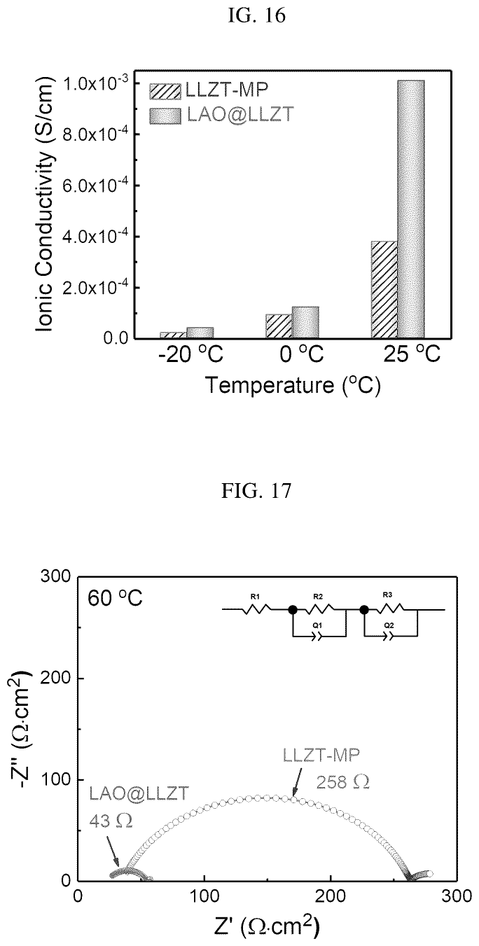

FIG. 17 shows the interfacial resistance between lithium and the fabricated solid electrolyte sintered bodies.

In this experiment, test specimens were prepared by mirror-polishing both surfaces of the sintered solid electrolyte and depositing lithium metal on both sides.

Interfacial resistance was measured using impedance spectroscopy: an AC voltage with an amplitude of 100 mV was applied over a frequency range of 500 Hz to 3 MHz, and the resistance was determined from the real-axis intercept of the semicircular Nyquist plot.

As shown in FIG. 17, the sintered body fabricated using a Li—Al—O coated solid electrolyte powder exhibits lower interfacial resistance with lithium compared to LLZT-MP.

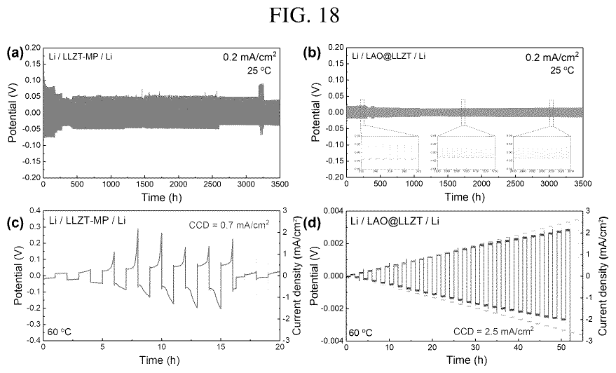

FIG. 18 presents the results of long-term stability and critical current density (CCD) measurements of the lithium-electrolyte interface. These evaluations are crucial for assessing the reliability of solid electrolytes, which require low-voltage, long-duration lithium cycling, and high CCD tolerance.

The specimens were prepared similarly, with both sides of the polished solid electrolyte coated with lithium metal.

Long-term stability was assessed by applying a constant current density in charge/discharge cycles, monitoring voltage behavior over time.

CCD was measured by incrementally increasing current density during charge/discharge cycles until short-circuiting occurred.

According to FIG. 18, the LAO@LLZT sintered body (b) shows superior long-term stability with lithium compared to LLZT-MP (a).

At room temperature, it sustained a current density of 0.2 mA/cm² for over 3,500 hours without overvoltage, while LLZT-MP did not.

In terms of critical current density, LAO@LLZT (d) remained stable at much higher current densities compared to LLZT-MP (c), withstanding up to 2.5 mA/cm².

These findings demonstrate that sol-gel coating of solid electrolyte particles with Li—Al—O compounds enables the fabrication of sintered bodies (pellets, sheets, thin films) with high sinterability, density, phase stability, ionic conductivity, and lithium interfacial stability-all without the need for mother powder.

The inventors further confirmed that these remarkable effects were only observed when LiAlO₂ was applied as a sol-gel surface coating, not when used in powder form. This highlights a clear distinction from conventional additive-based sintering.

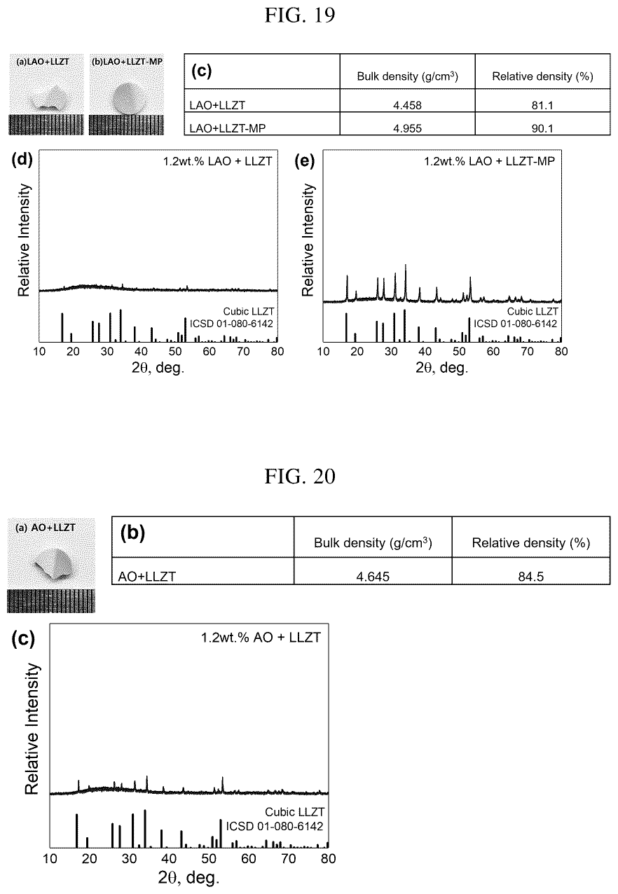

FIG. 19 shows images and performance comparison graphs of LLZT samples with 1.2 wt. % LiAlO₂ powder added.

When mother powder (MP) was used, the sintered body had a relatively low sinterability (˜90%) but remained intact with partial crystallinity.

However, without mother powder (bare), the sintered body broke apart, showing low density and collapsed crystallinity.

Even with additional materials and cost (mother powder), sinterability remained limited compared to Example 1's 96.1% relative density.

Thus, the sintered body of the present invention consists of a core made of sintered LLZT particles, and a grain boundary phase where the Li—Al—O compound is distributed.

Despite the absence of mother powder, this structure achieves a relative density ≥95%, specifically 96.1%, and maintains a stable cubic phase structure with suppressed lithium volatilization, as confirmed by XRD.

FIG. 20 presents the sintered structure and performance of LLZT samples with 1.2 wt. % Al₂O₃ powder. When mother powder was not used, the sintered bodies fractured, and both density and crystallinity were significantly degraded. This shows that Al—O additives cannot replicate the sinterability and structural stability achieved by sol-gel coated Li—Al—O compounds.

The comparison of FIGS. 19 and 20 with FIG. 2(c) (LAO@LLZT) confirms the superior sinterability, density, and phase stability of the sol-gel coated sample. Therefore, sol-gel coating of Li—Al—O compounds onto the surface of solid electrolyte powders is essential and represents a key technical feature of this invention-enabling sintered solid electrolytes without the use of mother powder.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims. The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. A powder for an oxide-based solid electrolyte comprising:
a base powder; and
a coating layer on a surface of the base powder, wherein the coating layer comprising a Li—Al—O compound.

2. The powder of claim 1, wherein the base powder is free of a Li—Al—O compound.

3. The powder of claim 1, wherein the base powder is selected from the group consisting of a Garnet-type Li₇La₃Zr₂O₁₂ (LLZ) powder, and a Ta-doped Li_{6.4}La₃Zr_{1.4}Ta_{0.6}O₁₂ (LLZT) powder.

4. The powder of claim 1, wherein the coating layer is coated by a sol-gel method in an amount of 0.5 wt % to 5.0 wt % with respect to the base powder.

5. A method for manufacturing an oxide-based solid electrolyte sintered body comprising:
coating a base powder with a material comprising a Li—Al—O compound to form a coated powder; and
sintering the coated powder, wherein the sintering is performed without a mother powder.

6. The method of claim 5, wherein the coating is performed using a sol-gel solution comprising a lithium precursor and an aluminum precursor.

7. The method of claim 5, wherein the base powder is a Garnet-type Li₇La₃Zr₂O₁₂ (LLZ) powder or a Ta-doped Li_{6.4}La₃Zr_{1.4}Ta_{0.6}O₁₂ (LLZT) powder.

8. The method of claim 7, wherein the base powder is free of a Li—Al—O compound.

9. The method of claim 8, wherein the sintering is performed immediately after the coating without a separate crystallization process.

10. The method of claim 9, wherein the sintering is performed in an oxygen atmosphere at a temperature of 1000° C. to 1100° C.

11. The method of claim 8, wherein the manufactured solid electrolyte sintered body has a relative density of at least 95% and a shrinkage rate that is increased by at least 15% compared to a comparative sintered body manufactured by sintering an uncoated powder without a mother powder.

12. The method of claim 10, wherein the manufactured solid electrolyte sintered body maintains a cubic phase without structural collapse and is free of a secondary phase.

13. An oxide-based solid electrolyte sintered body comprising:
a core comprising Ta-doped Li₇La₃Zr₂O₁₂ (LLZT); and
a Li—Al—O compound distributed at grain boundaries of the core,
wherein the sintered body has a relative density of at least 95% and has a cubic phase.

14. An all-solid-state secondary battery comprising the oxide-based solid electrolyte sintered body of claim 13.
